(19) United States
(12) Patent Application Publication
(10) Pub. No.: US 2024/0244418 A1
(43) Pub. Date: Jul. 18, 2024

(54) TERMINAL, COMMUNICATION SYSTEM, AND CONTROL METHOD

(71) Applicant: NTT DOCOMO, INC., Tokyo (JP)

(72) Inventors: Tetsuhiro Sasagawa, Tokyo (JP); Syunsuke Oohara, Tokyo (JP); Yosuke lizuka, Tokyo (JP); Kenji Hashimoto, Tokyo (JP)

(73) Assignee: NTT DOCOMO, INC., Tokyo (JP)

(21) Appl. No.: 18/558,960

(22) PCT Filed: May 7, 2021
(86) PCT No.: PCT/JP2021/017549

§ 371 Date: Nov. 3, 2023

(51) Int. Cl. H04W 8/20; H04L 67/55; H04W 8/18

(52) U.S. Cl. CPC H04W 8/20; H04L 67/55; H04W 8/183

(57) ABSTRACT

A terminal receives a download notification of a profile configured in an embedded subscriber identification module from a push server. The terminal accesses the download destination in accordance with the download notification and receives the profile. The terminal configures the profile to the embedded subscriber identification module. In other aspects, a communication system, a method for controlling a terminal, and a method for controlling a communication system are also disclosed.

### TECHNICAL FIELD

The present invention relates to a terminal, communication system, and control method for performing radio communication, in particular, a terminal, communication system, and control method supporting a profile download operation of an embedded subscriber identification module.

### BACKGROUND ART

In the GSM Association (GSMA), Remote subscriber Identification Module Provisioning (RSP) is prescribed to allow a terminal to download a profile consisting of data including subscriber information and an application for controlling the use of the communication service from a network at the time of a contract for using the communication service (see Non-Patent Literature 1).

In the RSP, the terminal configures the downloaded profile to an embedded subscriber identification module (eSIM: Embedded Subscriber Identity Module). Thus, the terminal can perform the communication line opening processing at the time of the contract of using the communication service via the network using the eSIM. The software part whose profile is rewritten is called the eSIM, while the hardware part is called the eUICC (Embedded Universal Integrated Circuit Card).

FIG. 7 is a diagram showing problems in the consumer model of the eSIM specification. As shown, the communication system in the consumer model of the eSIM specification includes a Subscription Manager Data Preparation+ (SM-DP+) server that provides profiles and a Subscription Manager Discovery Server (SM-DS) server that searches for profiles provided to eSIM.

That is, in the current standard specification, SM-DS is used for information acquisition of SM-DP+ that downloads profiles to eSIM for connection to a network (NW) because there is no connection with a specific carrier, and SM-DS guides SM-DP+ whose profiles are prepared by access from a terminal.

### CITATION LIST

### Non-Patent Literature

[Non-Patent Literature 1]

GSMA SGP. 21 RSP Architecture Version 2.2, September 2017

### SUMMARY OF INVENTION

However, as shown by the dotted line in FIG. 7, even when the profile was ready on the SM server, the SM server could not inform that the opening preparation (profile preparation) was ready because it could not access the terminal.

In addition, if the terminal is configured to periodically access the SM server to check whether it is ready to open, unnecessary traffic and server burden increase.

Accordingly, the present invention has been made in view of such a situation, and it is an object of the present invention to provide a server, a communication system, and a control method capable of accurately transmitting information that the profile is ready while preventing unnecessary traffic and server burden on the profile download of the eSIM-mountable terminal.

A terminal (200) according to one aspect of the present invention is provided with a first reception unit (220) that receives a download notification of a profile (250) configured in an embedded subscriber identification module from a push server (400-3), a second reception unit (220) that accesses a download destination in accordance with the download notification and receives the profile, and a control unit (240) that configures the profile in the embedded subscriber identification module (250).

A communication system according to one aspect of the present invention includes: a first server (400-3) that transmits a download notification of a profile configured in an embedded subscriber identification module (250) to a terminal (200); and a second server (400-1) that transmits the profile to the terminal (200) when the terminal (200) accesses the terminal in accordance with the download notification.

A method for controlling a terminal according to one aspect of the present invention includes: receiving a download notification of the profile configured in the embedded subscriber identification module (250) from a push server (400-3); accessing a download destination in accordance with the download notification and receiving the profile; and configuring the profile to the embedded subscriber identification module (250).

A method for controlling a communication system according to one aspect of the present invention includes: transmitting a download notification of the profile configured in the embedded subscriber identification module (250) to a terminal (200); and transmitting the profile to the terminal (200) when the terminal (200) accesses the terminal in accordance with the download notification.

### BRIEF DESCRIPTION OF DRAWINGS

FIG. 1 is an overall schematic configuration diagram of the communication system 10.

FIG. 2 is a functional block configuration diagram of the terminal 200.

FIG. 3 is a functional block diagram of the SM server 400 having a push notification function.

FIG. 4 is a diagram showing an operation flow in a conventional communication system.

FIG. 5 is a diagram showing an operation flow in the communication system 10 of the present embodiment.

FIG. 6 is a diagram showing an example of a hardware configuration of the radio base station 100, the terminal 200, the contract site 300, the SM server 400, the customer management system 500, and the information management server 600.

FIG. 7 is a diagram showing problems in the consumer model of the conventional eSIM specification.

### MODES FOR CARRYING OUT THE INVENTION

Exemplary embodiments of the present invention are explained below with reference to the accompanying drawings. The same functions and configurations are denoted by the same or similar symbols, and their descriptions are omitted accordingly.

### (1) Overall General Configuration of the Communication System

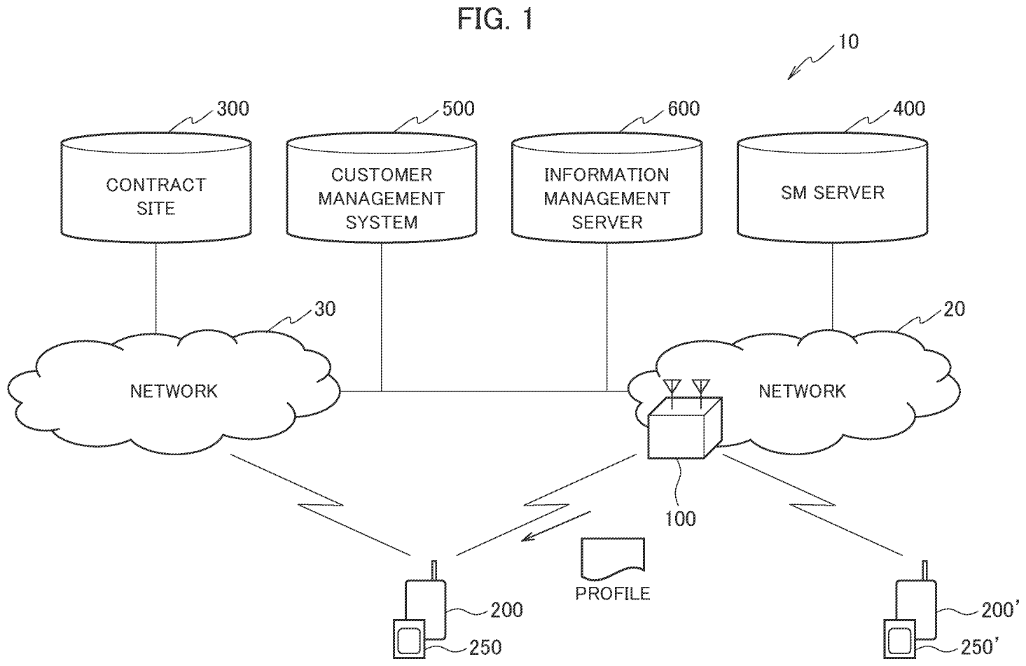

FIG. 1 is an overall general schematic configuration diagram of a communication system 10 according to the present embodiment.

As shown in FIG. 1, the communication system 10 includes, by way of example, a network 20 such as a 3GPP network, a network 30 such as a non-3GPP network, a radio base station 100, a terminal 200, a contract site 300, a subscription management (SM) server 400, an information management server 600, and a customer management system 500. The terminal is also referred to as a User Equipment (UE). The contract site is also referred to as an operator or carrier. The specific configuration of the communication system 10 including the number of devices (contract site 300, subscription management (SM) server 400, information management server 600, customer management system 500, etc.), radio base stations and terminals of the network is not limited to the example shown in FIG. 1. For example, the server on the network side may be at least one device implementing the present invention, and in the following embodiments, at least one device of the radio base station 100, the contract site 300, the subscription management (SM) server 400, the information management server 600 and the customer management system 500 may be omitted, and the functions of the device may be possessed by other devices.

The network 20 is a 5G (NR) (or 6G) network, such as a 3GPP network, and includes a Next Generation-Radio Access Network (NG-RAN, not shown) and a core network (5G-CN, not shown). The NG-RAN includes an NG-RAN Node, specifically a radio base station 100 (gNB or ng-eNB), connected to a 5G-CN (or 6G. same as below).

The radio base station 100 performs radio communication in accordance with NR or 6G between the radio base station 100 and the terminal 200.

The radio base station 100 and the terminal 200 can support Massive MIMO, which generates a more directional beam by controlling radio signals transmitted from multiple antenna elements; Carrier Aggregation (CA), which uses multiple component carriers (CCs); Dual Connectivity (DC), which simultaneously transmits CCs between multiple NG-RAN Nodes and the terminal; and Integrated Access and Backhaul (IAB), which integrates radio backhaul between radio communication nodes such as gNB and radio access to the UE. The CC is also called a carrier.

The network 20 may be a network according to LTE instead of NR or 6G. In this case, the 3GPP network 20 includes an Evolved Universal Terrestrial Radio Access Network (E-UTRAN) and an Evolved Packet Core (EPC). The E-UTRAN includes a radio base station (eNB or en-gNB) and is connected to an EPC.

The network 30 may be a non-3GPP network or the like, a wireless local area network (wireless LAN) such as wireless fidelity (Wi-Fi), or a wired LAN. The network 30 is not particularly limited to a network where the terminal 200 can access the contract site 300 using a uniform resource locator (URL) or the like.

The terminal 200 executes an RSP for downloading a profile comprising data including subscriber information and an application for controlling the use of the communication service from the 3GPP network 20 at the time of the contract for using the communication service. The profile may be called a production profile.

The subscriber information may include an International Mobile subscriber Identifier (IMSI) that is uniquely assigned to the user using the communication service, a telephone number that is uniquely assigned to the user using the communication service, and contract information that includes a pricing plan applicable to the terminal 200. The subscriber information is provided from the contract site 300.

In the RSP, when attaching to the 3GPP network 20, the terminal 200 may transmit a request to download a profile corresponding to an AC (Activation Code) received from the network 30 at the time of the communication service contract to the radio base station 100 via the 3GPP network 20. When the request for a profile is received from the terminal 200, the radio base station 100 may transmit (transfer) the request to the SM server 400.

The contract site 300 is connected to a network (network 20 and/or network 30). When the contract site 300 receives the contract information (IMEI, EID, etc.) based on the communication contract, it transmits the contract information to the customer management system 500, and the customer management system 500 may transmit a profile generation request (profile preparation instruction) based on the contract information to the SM server 400. The customer management system 500 may transmit the EID, IMEI, telephone number, etc. included in the contract information to the SM server 400.

The SM server 400 is connected to a network (network 20 and/or network 30). When the SM server 400 receives a profile generation request (profile preparation instruction), it generates a profile and transmits it to the terminal 200. In this embodiment, the SM server 400 has a push notification function that transmits a profile download notification indicating that the profile is prepared to the terminal 200, and transmits the profile to the terminal when the terminal 200 accesses the profile based on the download notification. The communication may be 2 round trips, and the SM server 400 may transmit the information of the download destination to the terminal 200 when the terminal 200 accesses the access destination in accordance with the download notification, and may transmit the profile when the terminal 200 accesses the download destination.

As described later, the functions of the SM server 400 may be distributed among a plurality of servers. For example, the functions may be distributed among a plurality of devices as follows: a push server 400-3 having a push notification function for transmitting a profile download notification (e.g., SM-DS access instruction) indicating that the profile is ready to the terminal 200; a SM-DS server 400-2 for transmitting the information of the download destination (e.g., SM-DP+ address) to the terminal 200 when the access destination according to the download notification is accessed from the terminal 200; and a SM-DP+ server 400-1 for transmitting the profile when the access destination is accessed from the terminal 200. As described above, the function distribution and function aggregation of the functions of this embodiment can be arbitrarily configured. As an example of the server of the present invention, the SM server 400, the SM-DP+ 400-1, the SM-DS server 400-2, the push server 400-3, and the like may be described in this (including the customer management system 500 or the information management server 600, etc.) embodiment as examples.

The SM server 400 may transmit information (e.g., AC) including the SM address and the Matching ID (identifier associated with the profile) to the customer management server 500 or the like. The customer server 500 may transmit AC to the contract site 300, and the contract site 300 may transmit AC to the terminal 200 via the network 30.

The customer management system 500 is connected to a network and manages contract information such as subscriber information. For example, the customer management system 500 maintains contract information (For example, IMEI, EID, etc. of the terminal 200) based on information at the time of contract of a mobile phone. The customer management system 500 may also transmit contract information to the customer management server 500 and the SM server 400. The entity that holds contract information, the entity that receives requests, and the entity that transmits instruction information may be any of, for example, the contract site 300, the SM server 400, the information management server 600, and the customer management system 500. For example, the information management server 600 may be connected to a network, hold information on the terminal 200 in a reference table, and transmit the terminal information to a network device such as the SM server 400 in response to a request or inquiry from the network.

### (2) Function Block Configuration of Communication System

Next, the function block configuration of communication system 10 will be described. Specifically, the function block configuration of terminal 200 and SM server 400 will be described. Hereinafter, only the parts related to the features in this embodiment will be described. Accordingly, the terminal 200 and the SM server 600 may of course include other functional blocks not directly related to the features of the present embodiment. In addition, some or all of the functions of the contract site 300, the information management server 600, the customer management system 500, the SM server 400, the radio base station 100, and the like may be held on behalf of another device, which may include the following functional block configuration (transmission unit, reception unit, control unit) of the SM server 400.

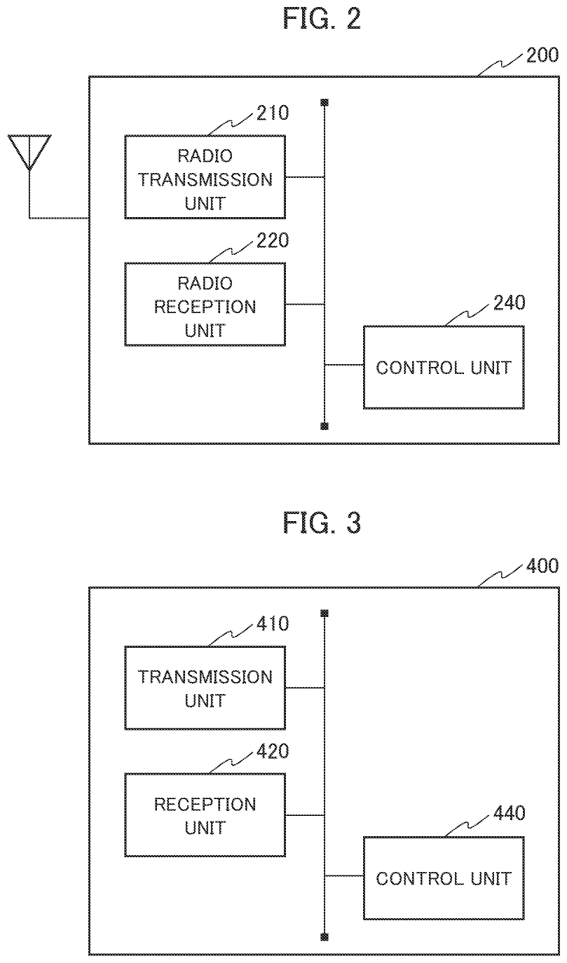

For convenience, a functional block configuration diagram of the terminal 200 will be described first. FIG. 2 is a functional block configuration diagram of the terminal 200. As shown in FIG. 2, the terminal 200 includes a radio transmission unit 210, a radio reception unit 220, and a control unit 240.

The radio reception unit 220 receives a downlink signal (DL signal) in accordance with NR (or 6G. hereinafter the same) from the radio base station 100. In this embodiment, the radio reception unit 220 functions as a first reception unit that receives a download notification of the profile configured in the embedded subscriber identification module 250 from the push server 400 (400-3) and a second reception unit that accesses the download destination (400-1) in accordance with the download notification and receives the profile. The radio reception unit 220 may acquire the information of the download destination (400-1) from the access destination (400-2) in accordance with the download notification and receive the profile from the download destination (400-1).

The radio transmission unit 210 transmits an uplink signal (UL signal) in accordance with the NR (or 6G) to a radio base station 100, a contract site 300, or the like. In this embodiment, the radio transmission unit 210 functions as a transmission unit that transmits terminal information (IMEI, EID, etc.) to the push server 400 (400-3). In addition, the radio transmission unit 210 may transmit contract information to the contract site 300 or the like. The radio transmission unit 210 may also transmit a profile download request or the like to the SM server 400 (400-1, 400-2). Detailed specific examples will be described later.

The radio transmission unit 210 and the radio reception unit 220 execute radio communication via a control channel or a data channel.

The control channel includes a physical downlink control channel (PDCCH), a physical uplink control channel (PUCCH), a physical random access channel (PRACH), and the like.

The data channel includes a physical uplink shared channel (PDSCH), a physical uplink shared channel (PUSCH), and the like.

The control unit 240 has functions such as a local profile assistant (LPA), downloads a profile from the SM server 400, and installs (configures) the profile in the eSIM 250.

The eSIM 250 is a software part to which the profile is written. The hardware part to which the profile is written is called an embedded universal accumulation circuit card (eUICC).

With the profile installed in the eSIM 250, the network may be configured to control the active/inactive status of the profile, i.e., the availability/unavailability of the eSIM, without physically inserting or removing subscriber Identification Module (SIM).

When the activated profile does not exist in the eSIM 250, the eSIM 250 is recognized from the network side as a SIM to which no profile has been written.

The eSIM 250 has a shape that is not removable from the terminal 200, but is not limited thereto, and may be removable from the terminal 200.

In addition, the control unit 240 controls each functional block that constitutes the terminal 200. control unit 240 executes the operation of attaching to the 3GPP network 20.

FIG. 3 is a functional block diagram of the SM server 400. As shown in FIG. 3, the SM server 400 includes a transmission unit 410, a reception unit 420, and a control unit 440. In the present embodiment, the SM server 400 includes a push notification function, but as described above, the device having the push notification function may be configured as a separate housing (400-3).

The reception unit 420 receives various kinds of information (Examples: terminal information, contract information, profile preparation instructions, profile download requests, etc.) via a network. In particular, in this embodiment, the reception unit 420 receives terminal information of the push notification destination of the download notification.

The transmission unit 410 transmits various kinds of information (Example: token for terminal information, SM-DS access indication, SM-DP+ address, profile, query information, request, indication information, etc.) through the network. In this embodiment, the transmission unit 410 may transmit answer information (tokens, etc.) to the terminal 200 that has transmitted the terminal information. When the profile is ready, the transmission unit 410 may transmit a download notification (e.g., an SM-DS access instruction as the first access destination) to the terminal 200. The transmission unit 410 may also transmit a profile download destination (e.g., an SM-DP+ address) to the terminal 200 that has accessed the access destination (e.g., SM-DS).

The control unit 440 controls each functional block that constitutes the information management server 600. In this embodiment, the control unit 140 generates a profile in response to a profile preparation instruction from the customer management system 500 or the like.

### (3) Operation of the Communication System

Next, the operation of the communication system 10 will be described. In the following example, the functions of the SM server 400 will be described as follows 200: a push server 400-3 having a push notification function for transmitting a profile download notification (e.g., SM-DS access instruction) indicating that the profile is ready to the terminal 400; a SM-DS server 400-2 for transmitting the information of the download destination (e.g., SM-DP+ address) to the terminal 200 when the terminal 200 accesses the access destination in accordance with the download notification; and a SM-DP+ server 400-1 for transmitting the profile when the terminal 200 accesses the download destination. In the following example, as described above, the terminal 200 receiving the push notification and the SM server side perform 2 round trip signaling for the profile download, but this is not limited to 1 round trip and may be 3 or more round trips.

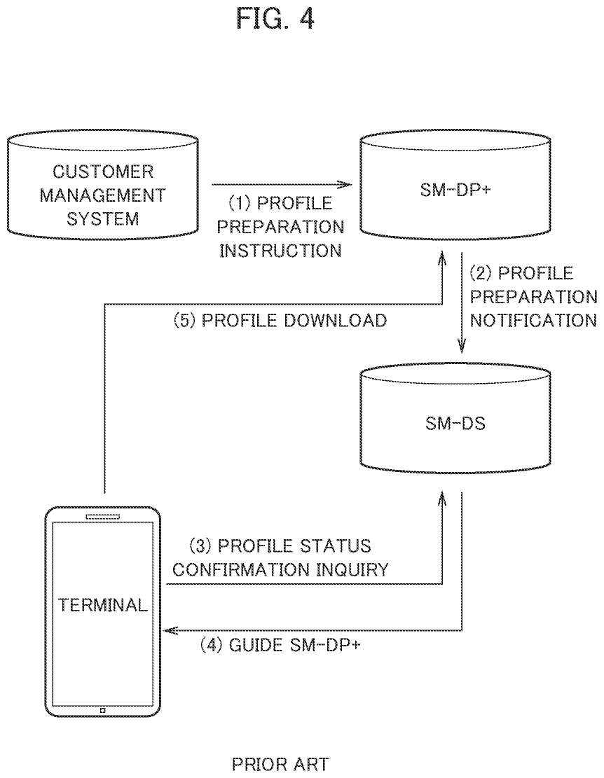

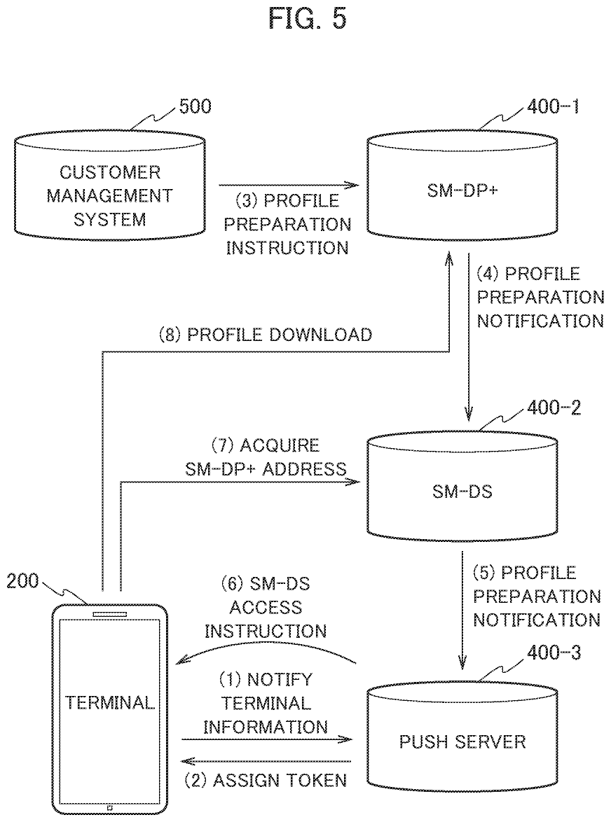

FIG. 4 is a flow diagram showing an operation example in the consumer model of the conventional eSIM standard specification, and FIG. 5 is a flow diagram showing an operation example of the present embodiment.

As shown in FIG. 4, conventionally (1) when the customer management system transmits a profile preparation instruction to the SM-DP+ server, (2) the SM-DP+ server notifies the SM-DS server of profile generation. When (3) the terminal 200 receives a confirmation inquiry of the generation status of the profile to the SM-DS server, (4) the SM-DS server transmits the SM-DP+ address to the terminal, and (5) the terminal downloads the profile from the SM-DP+ server based on the SM-DP+ address.

Thus, even when the profile is ready on the SM server side, the SM server side could not directly notify the terminal. Therefore, as described above, it was necessary for the terminal to perform information communication to confirm whether or not the profile is ready on the SM server side, resulting in unnecessary traffic and an increase in the server burden.

Therefore, in the operation example of this embodiment, the push server 400-1 on the SM server side has a push notification function for a profile download notification indicating that the profile is ready. The processing procedure will be described in detail below.

More specifically, as shown in FIG. 5, the terminal 200 first notifies the push server 400-3 of its terminal information (IMEI, EID, etc.) (step 1).

Then, the push server 400-3 receives the terminal information and assigns a token to the terminal 200 indicating that it has become a push notification object (step 2).

When the customer management system 500 transmits a profile preparation instruction to the SM-DP+ server 400-1 (step 3), the SM-DP+ server 400-1 transmits a profile generation notification to the SM-DS server 400-2 (step 4). Then, the push server 400-3 transmits the SM-DS access instruction information indicating that the profile has been prepared to the terminal 200 to the terminal 200 (step 6).

Then, the terminal 200 accesses the SM-DS server 400-2 based on the SM-DS access instruction information and acquires the SM-DP+ address as the download destination from the SM-DS server 400-2 (step 7).

Then, the terminal 200 accesses the SM-DP+ server 400-1 based on the SM-DP+ address and downloads the profile from the SM-DP+ server 400-1 (step 8).

The above is an example of the operation of the present embodiment.

### (4) Operational Effects

According to the above-described embodiment, the terminal (200) includes a first reception unit (220) that receives a download notification of a profile (250) configured in the embedded subscriber identification module from a push server (400-3), a second reception unit (220) that accesses a download destination in accordance with the download notification and receives the profile, and a control unit (240) that configures the profile in the embedded subscriber identification module (250).

As a result, since the terminal (200) is explicitly instructed that the profile can be downloaded, the terminal ( ) can accurately receive information on the profile download of the eSIM-mountable terminal that the profile is ready while preventing unnecessary traffic and server burden.

In this embodiment, the terminal (200) transmits the terminal information to the push server in advance.

Thus, the push notification of profile preparation from the push server can be surely received.

In this embodiment, the terminal 200 acquires the information of the download destination (SM-DP+ server) from the access destination (SM-DS server) in accordance with the download notification, and receives the profile from the download destination.

Thus, in the consumer model of the eSIM specification, the profile can be downloaded from the profitable notification in two round trips.

In this embodiment, the push server (400-3) is a download destination (400-1) or an access destination (400-2).

Thus, the push notification function of the profile download notification can be included in the SM server 400, the SM-DP+ server 400-1, and the SM-DS server 400-2, and the functions can be linked.

### (5) Other Embodiments

Although the contents of the present invention have been described in accordance with the above embodiments, the present invention is not limited to these descriptions, and it is obvious to those skilled in the art that various modifications and improvements can be made.

The block diagram (FIGS. 2 and 3) used in the description of the above embodiments shows a block of functional units. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (structural component) that causes transmitting may be called a transmitting unit or a transmitter. For any of the above, as explained above, the realization method is not particularly limited to any one method.

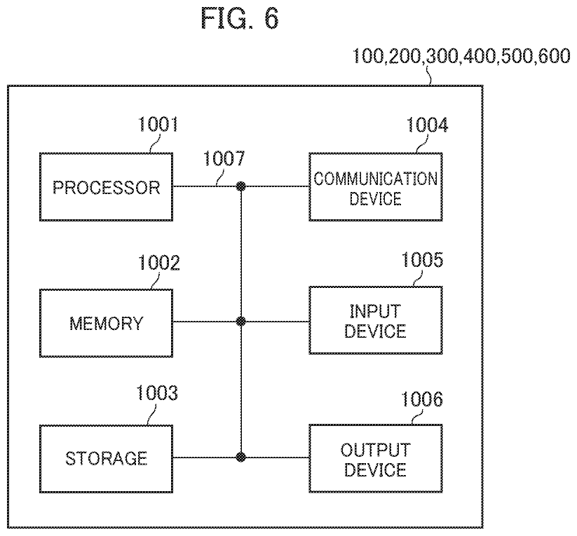

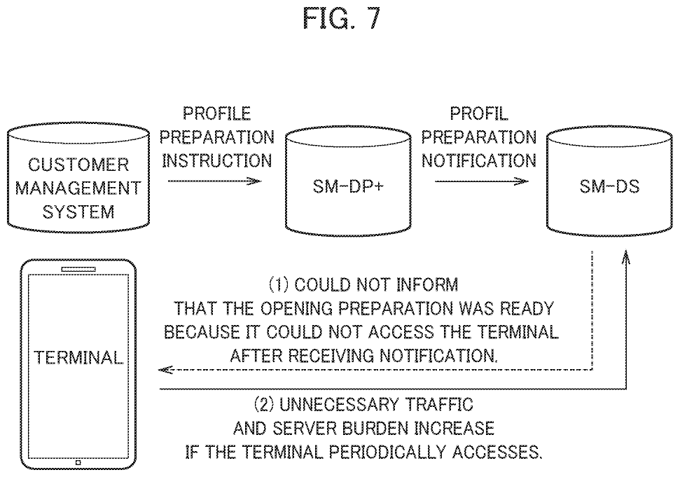

Furthermore, the radio base station 100, the terminal 200, the contract site 300, the SM server 400, the customer management system 500, and the information management server 600 described above may function as a computer for processing the radio communication method of the present disclosure. FIG. 6 is a diagram showing an example of a hardware configuration of the device. As shown in FIG. 6, the device may be configured as a computer device including a processor 1001, a memory 1002, a storage 1003, a communication device 1004, an input device 1005, an output device 1006 and a bus 1007.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

Each functional block of the device may be implemented by any hardware element or combination of hardware elements of the computer device.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

The processor 1001, for example, operates an operating system to control the entire computer. Processor 1001 may be configured with a central processing unit (CPU) including an interface to peripheral devices, a controller, a computing device, a register, etc.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), or the like. The memory 1002 may store a program (program code), a software module, or the like capable of executing a method according to an embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Each device, such as the processor 1001 and the memory 1002, is connected by a bus 1007 for communicating information. The bus 1007 may be configured using a single bus or a different bus for each device.

In addition, the device may comprise hardware such as a microprocessor, a digital signal processor (DSP), an application specific integrated circuit (ASIC), a programmable logic device (PLD), a field programmable gate array (FPGA), or the like, which may provide some or all of each functional block. For example, the processor 1001 may be implemented by using at least one of these hardware.

Information notification is not limited to the aspects/embodiments described in the present disclosure and may be performed using other methods. For example, information notification may be performed by physical layer signaling (e.g., Downlink Control Information (DCI), Uplink Control Information (UCI), higher layer signaling (e.g., RRC signaling, Medium Access Control (MAC) signaling, Notification Information (Master Information Block (MIB), System Information Block (SIB)), other signals, or a combination thereof. RRC signaling may also be referred to as RRC messages, e.g., RRC Connection Setup messages, RRC Connection Reconfiguration messages, etc.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing procedures, sequences, flowcharts, etc. of the embodiments/embodiments described in the present disclosure may be rearranged as long as there is no conflict. For example, the method described in the present disclosure presents the elements of the various steps using an exemplary sequence and is not limited to the particular sequence presented.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from a higher layer (or lower layer) to a lower layer (or higher layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each of the embodiments/embodiments described in the present disclosure may be used alone, in combination, or alternatively with execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of the channels and symbols may be a signal (signaling). The signal may also be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS),” “user terminal,” “user equipment (User Equipment: UE),” “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile may be a vehicle (For example, cars, planes, etc.), an unmanned mobile (For example, drones, self-driving cars,), or a robot (manned or unmanned). At least one of a base station and a mobile station can be a device that does not necessarily move during the communication operation. For example, at least one of a base station and a mobile station may be an Internet of Things (IOT) device such as a sensor.

The base station in the present disclosure may be read as a mobile station (user terminal, hereinafter the s same). For example, each aspect/embodiment of the present disclosure may be applied to a configuration in which communication between a base station and a mobile station is replaced by communication between a plurality of mobile stations (For example, it may be called device-to-device (D2D), vehicle-to-everything (V2X), etc.). In this case, the mobile station may have the function of the base station. Further, words such as “up” and “down” may be replaced with words corresponding to communication between terminals (For example, “side”). For example, terms an uplink channel, a downlink channel, or the like may be read as a side channel.

Similarly, the mobile station in the present disclosure may be replaced with a base s station. In this case, the base station may have the function of the mobile station.

A radio frame may be composed of one or more frames in the time domain. Each frame or frames in the time domain may be referred to as a subframe.

A subframe may be further configured by one or more slots in the time domain. The subframe may be a fixed time length (For example, 1 ms) independent of numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. PDSCH (or PUSCH) transmitted in units of time greater than the minislot may be referred to as PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one of the subframe and the TTI may be a subframe (1 ms) in the existing LTE, a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. The number of slots (number of minislots) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain. The number of subcarriers included in RB may be, for example, twelve, and the same regardless of the topology. The number of subcarriers included in the RB may be determined based on the neurology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (Sub-Carrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be specified by an index of the RB relative to the common reference point of the carrier. PRB may be defined in BWP and numbered within that BWP.

BWP may include UL BWP (UL BWP) and DL BWP (DL BWP). One or a plurality of BWPs may be configured in one carrier for the UE.

At least one of the configured BWPs may be active, and the UE may not expect to transmit and receive certain signals/channels outside the active BWP. Note that “cell,” “carrier,” and the like in this disclosure may be read as “BWP.”

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected”, “coupled”, or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access.” In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

Any reference to an element using a designation such as “first,” “second,” and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining”, “judging” and “deciding” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. In other words, “judgement” and “decision” may include considering some operation as “judged” and “decided”. Moreover, “judgment (decision)” may be read as “assuming”, “expecting”, “considering”, and the like.

In the present disclosure, the term “A and B are different” may mean “A and B are different from each other”. It should be noted that the term may mean “A and B are each different from C”. Terms such as “leave”, “coupled”, or the like may also be interpreted in the same manner as “different”.

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 communication system
20 (3GPP) network
30 (non-3 GPP) network
100 radio base station
200 terminal
210 radio transmission unit
220 radio reception unit
250 eSIM
240 control unit
300 contract site
400 subscription management (SM) server
400-1 SM-DP+ Server
400-2 SM-DS Server
400-3 Push Server
410 transmission unit
420 reception unit
440 control unit
500 customer management system
600 information management server
1001 processor
1002 memory
1003 storage
1004 communication device
1005 input device
1006 output device
1007 bus

1. A terminal comprising:
a first reception unit that receives from a push server a download notification of a profile configured in an embedded subscriber identification module;
a second reception unit that accesses a download destination in accordance with the download notification and receives the profile; and
a control unit that configures the profile to the embedded subscriber identification module.

2. The terminal of claim 1, further comprising a transmission unit that transmits terminal information to the push server.

3. The terminal according to claim 1, wherein the second reception unit acquires information on the download destination from an access destination in accordance with the download notification, and receives the profile from the download destination.

4. The terminal according to claim 1, wherein the push server is the download destination or the access destination.

5. A communication system comprising:
a first server that transmits a download notification of a profile configured in an embedded subscriber identification module to a terminal; and
a second server that transmits the profile to the terminal when the terminal accesses in accordance with the download notification.

6. A method for controlling a terminal comprising the steps of:
receiving a download notification of a profile configured in the embedded subscriber identification module from a push server;
accessing a download destination in accordance with the download notification and receiving the profile; and
configuring the profile to the embedded subscriber identification module.

7. A method for controlling a communication system comprising the steps of:
transmitting a download notification of a profile configured in an embedded subscriber identification module to a terminal; and
transmitting the profile to the terminal when the terminal accesses in accordance with the download notification.

8. The terminal according to claim 2, wherein the second reception unit acquires information on the download destination from an access destination in accordance with the download notification, and receives the profile from the download destination.

9. The terminal according to claim 2, wherein the push server is the download destination or the access destination.

10. The terminal according to claim 3, wherein the push server is the download destination or the access destination.
